(19) United States
(12) Patent Application Publication
(10) Pub. No.: US 2011/0261166 A1
(43) Pub. Date: Oct. 27, 2011

(54) Real vision 3D, video and photo graphic system

(75) Inventor: Eduardo Olazaran, Dallas, TX (US)

(73) Assignee: EDUARDO OLAZARAN, DALLAS, TX (US)

(21) Appl. No.: 12/799,279

(22) Filed: Apr. 21, 2010

(51) Int. Cl. H04N 13/02

(52) U.S. Cl. 348/47; 348/E13.074; 348/E13.075

(57) ABSTRACT

The present invention consists of a 3D video recording system, able to record two camera signals at one time in one unit, that emulates the natural human vision, that keeps the human scale of perception. The video signal is displayed in a Goggle system unit with two screens, one for each lens of the camera (right and left) on its respective side, and stereophonic audio. This system is able to record and play the 3D view and experience of being wherever the camera system is and/or goes, giving the operator or user the possibility of recording in many ways and environments, giving the user many options for recording and giving him/her the experience of being present, space and time, in the middle of a recorded event.

The present invention consists of a 3D video system, capable of recording two camera signals at one time in one unit, into a storage device (internal hard drive, compact disc, DVD, or other), where the lenses of the cameras are placed one at the side of the other in the same horizontal alignment at a distance of 2.5 inches from each other, to emulate the human vision at work. This apparatus becomes an extension of the human sight in a full 3D manner. The signals coming from the cameras unit is displayed in the viewfinders in the upper back of the camera body, or in a double-screen goggle unit where each channel of video is received in its correspondent side, right or left, according to the lenses of the cameras, with stereophonic audio. This system is able to record and play the 3D view and sound as perceived by the human eyes and ears, providing the experience of being exactly wherever the camera system is and/or goes, giving to the operator or user the possibility of recording in many ways and environments, with many options of recording, and providing the user the experience of being in the middle of an event from a remote location or time. FIG. 1 This apparatus consist of two video cameras 1 placed on the front of the unit, side to side with a separation in between the center of the lenses of 2.5 inches, and with two microphones 2 in the front outer corners of the cameras, one storage device (internal hard drive, CD, DVD, or other) to record the video and sound, assisted by an external control button panel unit 3, and two rotary 3D viewfinders 4, one for each eye, and 5 one fold-in screen, divided in two parts for left and right view, for optional monitoring of the recording sessions. For the best quality of displaying the recorded material, the goggle unit FIG. 2 with two screens, one for each correspondent eye, can be used.

### BACKGROUND OF THE INVENTION

Three dimensional video has been a big challenge with a number of solutions since the invention of video recording, but it has not offered a natural and satisfactory experience that our bare eyes can perceive in a stereo-vision fashion, as our ears perceive sounds, because in most of the existing 3D systems, both eyes are perceiving part of the view that corresponds to the opposite eye, to build the perception of the 3D view, and at the same time the vision corresponding to each eye, is not completely defined and pristine.

This real vision 3D system was inspired during the observation and realization that to be able to have a complete perception of the 3D, it is necessary to provide a separate image for each eye, and to deliver this image to the corresponding eye through a goggle unit with two separate screens, one for each eye, sending the data to the brain needed to build the experience of a 3D view. The unconscious natural perception of the size of the world we live in, depends on the distance between our two eyes because that distance is the reference for the brain to do its natural calculations of space and distance of everything around us, which determines our present location, where to move to, and what is the exact distance between ourselves and the objects before us. The idea came from the necessity of supplying one image to each eye in video fashion, and also having the option of changing the scale of perception (sizing the human view) depending on the distance between both lenses of the cameras.

### BRIEF SUMMARY OF THE INVENTION

The objective of the present invention is to provide a 3D video recording system that delivers a very natural and realistic experience of a video in the most simple way, just emulating the human vision system at work, which captures two sets of images using two cameras, one for each of our eyes, and takes them to a goggle unit that consists of two screens, left and right, to display every corresponding image coming from the cameras. This system overcomes the deficiencies of other 3D vision methods, where the creation of the 3D concept delivered to our eyes, depends on glasses with two different colors or Polaroid filters, or even more complicated and sophisticated equipment. This real vision 3D system is simply a double video camera unit and a double-screen goggle unit, working in coordination to provide a great and very effective result with a wide range of applications in all kinds of video production, such as the movie industry. This invention is the way to put your very eyes in a remote location or time in an impressive and realistic way, providing a revolutionary experience, especially when sizing the scale of perception, changing the distance between the lenses of the cameras, for a smaller or bigger scale.

This Real Vision 3D system provides the experience to “see the world with your own eyes”, with the option of seeing this world as through the sight of a giant or an ant.

### BRIEF DESCRIPTION OF THE SEVERAL VIEWS OF THE DRAWING

FIG. 1 Is a perspective view showing an outer face of the video 3D camera unit according to the detailed description of the invention.

FIG. 2 Is a perspective view showing the different parts of the 3D goggles unit.

FIG. 3 Is a perspective view showing the different parts of the 3D camera with detachable lenses from the video-control storage unit.

FIG. 4 Is a plan view of the attachable prismatic lenses to the front of the RV3D camera unit were the distance in between right and left lenses would be adjustable, on the sliding lenses.

FIG. 5 Is a perspective view showing the different parts of the 3D goggles unit for optical patients use, with the set of lenses attached in the front of the goggles.

FIG. 6 Is a perspective view with additional plan and elevation views the normal or regular scale of perception, when the distance in between center of the camera lenses is 2.5 inches.

FIG. 7 Is a perspective view with additional plan and elevation views of the way that the double distance than normal in between the video lenses affects the perception of the scale for smaller.

### DETAILED DESCRIPTION OF THE INVENTION

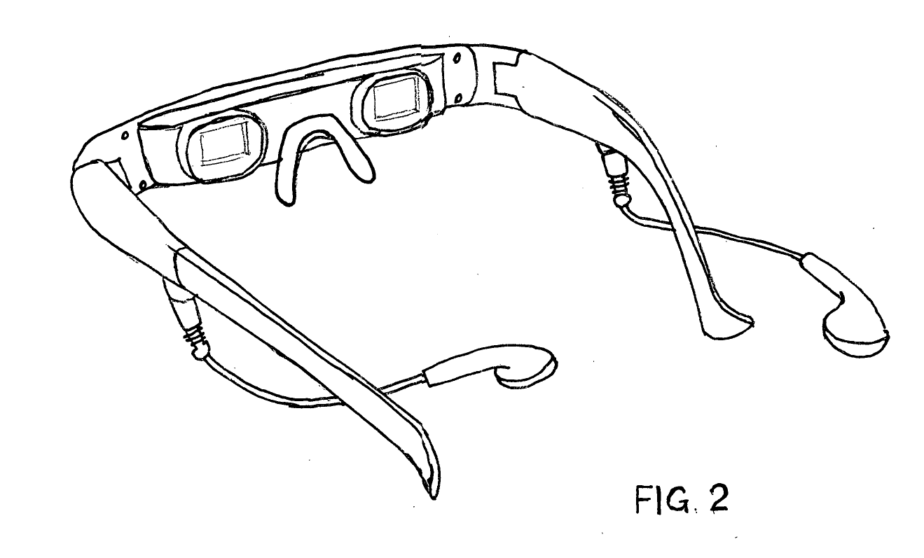

This apparatus consist of a 3D video camera unit that consists of two cameras 1, horizontally aligned and 2.5 inches of distance from the center of each lens, and two microphones 2 in the outer front sides of the camera's body, coordinated to record simultaneously into a storage unit (internal hard drive, CD, DVD, or other) and being controlled by a button control panel 3 for the record, play, stop, fast forward and rewind operations. The camera unit has a 3D viewfinder in the top back of the camera's body 4, one viewfinder per eye, to display the recorded images during or after the recording session, and also has a folding screen monitor to display both images coming from the camera lenses. This recorded material can also be displayed into the goggle unit FIG. 2, which consists of a double screen 6, one per eye, that provides the vision in an almost perfect 3D effect with very good quality, covering most of the view of each of the user's eyes. This is a very simple principle, but a solution that provides a 3D vision with unique results because it emulates the nature of the human sight at work, the way that our two eyes each collect a separate image and deliver the images to the brain to combine them and create the concept of space in 3D. It is exactly the same task but with two cameras in one unit keeping the same distance as that which is between both eyes and the same scale of perception, and delivering this view to the eyes of the operator or user, and giving the possibility of a wide range of use, mostly where precise view in remote location is required, adding a bigger range of applications of this system when using the variable distance between centers of the camera lenses, that produces the sizing of scale, for bigger or smaller scale of perception.

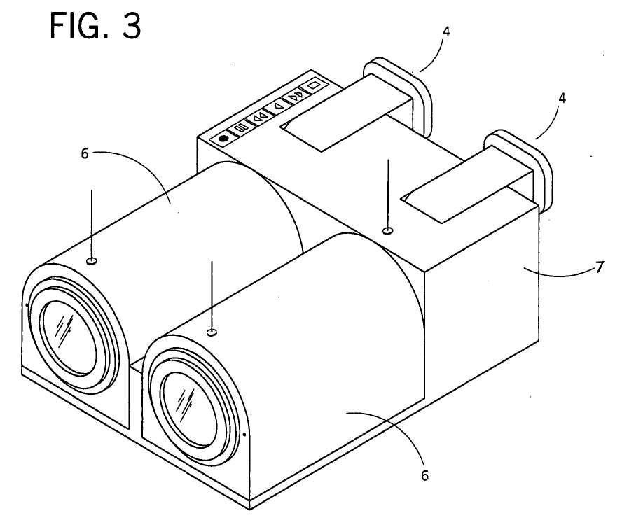

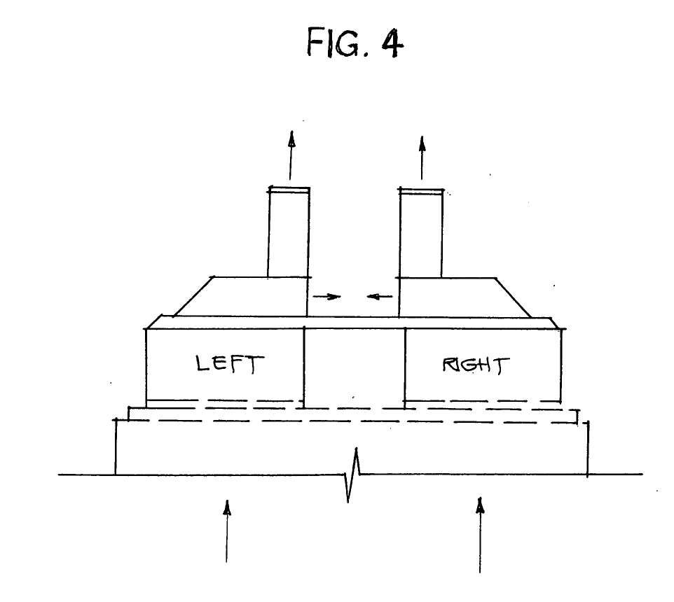

The camera operates by recording video images, 1 one per camera, right and left, as well as the sound through the 2 stereo microphones, 3 at the action of pressing the record button (after having been powered on), for the recording process. It stores the images in the designated storage device (internal hard drive, CD, DVD, or other) of the camera unit. To retrieve the video material, the user selects a video file and presses PLAY, to show the video images on the 4 viewfinders in the top back of the body of the camera, or in the 5 fold-in side screen, or in the goggle unit FIG. 2 for better quality display. For sizing the scale of perception with the variable distance bigger than 2.5 inches in between lenses of the two cameras, it is required a specially designed camera unit FIG. 3 for that purpose where both lenses are detachable from the video-control storage unit. For a smaller scale of perception, the two lenses would be brought closer to each other, decreasing the distance of 2.5 inches between them, and for that purpose it is required a specially designed camera unit FIG. 4.

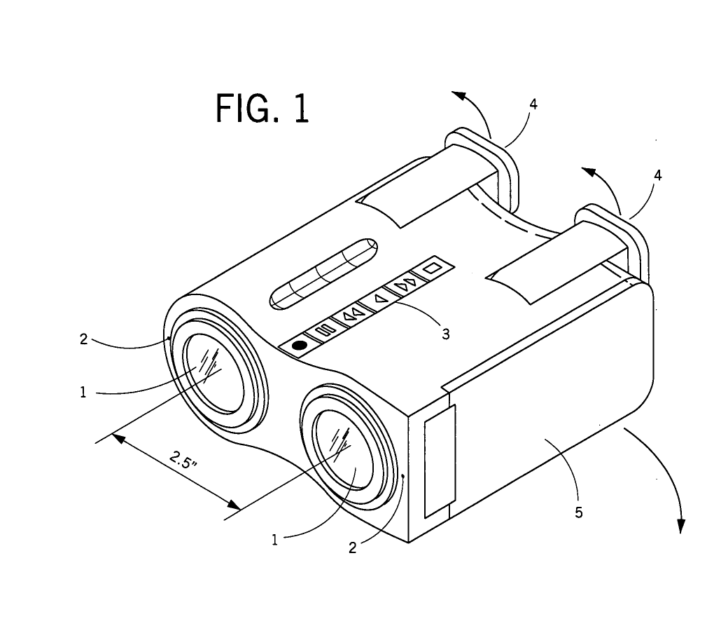

1. in this invention, is the Real Vision 3D (RV3D from henceforth) video system of combining two units in one, the 3D double camera unit FIG. 1 and the 3D double screen goggle unit FIG. 2, with the specific purpose of providing the natural human way of viewing and hearing 3D video and 3D photographic recording. The 3D video unit with the double lens camera FIG. 1, emulates the human eye's positions, separation and function, as described in the specifications. To display the recorded material, it takes the 3D double-screen 6 goggle unit FIG. 2 that covers most of the view of each eye, providing in this way the most natural perception of real 3D view, and giving a totally new realistic experience to be applied mainly in the movie industry, in a new kind of movies where the spectator has a totally different sensation of being part of the action, seeing through the eyes of any of the movie's characters at the time or being in the midst of the characters into the movie. This concept will allow the possibility to have RV3D Theaters with rooms where it will be possible to add more special physical effects, such as: vibrations (via sub-woofers or other means), sit movement, wind, smells and/or more. As a video recorder, the video system would act like an extension our sight, collecting the very same images that our eyes would. To be used in remote operated vehicles (ROV's) on any kind of environment (ground, underwater or airborne) to give the right scale of vision, in real time, to be able to be maneuvered and controlled, as if the operator would be in the action perceiving distances and depth of field for accurate control. Night vision or infrared capabilities can be optionally added to the RV3D. To be used as a web camera. To be used as surveillance cameras in sensitive areas for security, adding the option of zoom lenses, night vision and/or infrared capabilities on the RV3D, that makes the observation like having your eyes where the camera is. Another application is as a far-distance observation unit, with a distance between both cameras lenses changed to one of dozens of yards, able to perceive, with very accurate detail, the activities of a subject at hundreds of yards away, but with extremely good detail in 3D. To give the handicapped the possibility of experiencing many different situation that they would otherwise be unable to experience due to environmental risks, transportation difficulties, or other reasons. For example, to allow a quadriplegic person to experience skydiving or scuba diving without leaving his/her room. To be used in remote areas where there are not enough medical services, which the RV3D will serve as the doctor's eyes, allowing the doctor to watch in real scale, in 3D, and in real time, as if the doctor where present in the desired location. The RV3D may even be used in remote control surgeries with the help of robotic arms. It may also be simply used by doctors in several different locations, allowing them to witness surgeries or medical procedures with all the advantages of RV3D. To be used in remote control special mechanical procedures or for detailed observation in hazardous environments, such as outer space. Anybody can now be anywhere, watching without taking the physical risk of being at the location that is being viewed, but with the advantage of watching in Real Vision 3D. This system can be used in multiple sports judgment tasks, because of the 3D detailed observation. Another formidable use for the RV3D is as a dashboard camera in police patrol vehicles because as a witness, a recording would be much better evidence in 3D than the conventional video, and would be more beneficial because the real scale.

2. in this invention, according to the concept described in the claim #1, is having the Real Vision 3D System all together in one body unit, as shown in FIG. 1, where the 3D viewfinder is used to review the recorded material or to observe in real time as material is being recorded, without the need 3D Goggle unit, with the option of the fold-in side screen as a viewfinder.

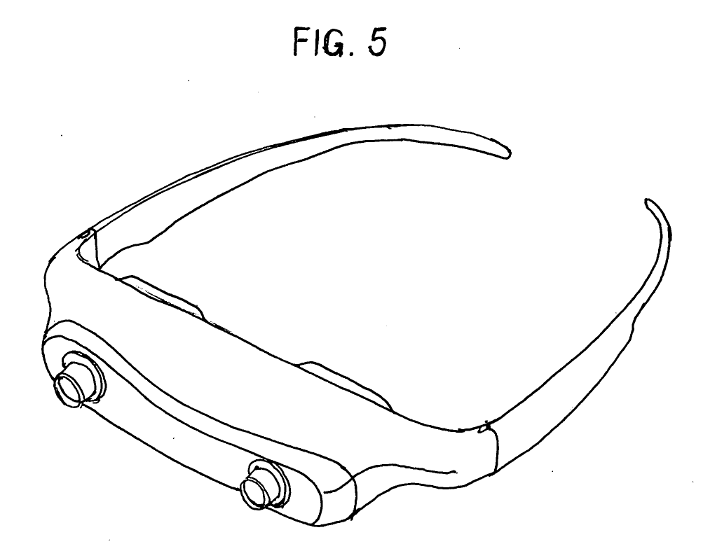

3. in this invention according to the concept described in the claim #1, is the system of using the Real Vision 3D like a medical optical device that can be adjusted in focus, contrast, distortion and every optical image option for patients with severe vision deficiencies, using the RV3D system in one unit (instead of two, as regular). The two cameras would be attached in front of the goggle unit FIG. 5 which would process the images for both eyes and adjust these images as required, in focus, contrast, image distortion, etc., with the possibility of adding night vision capabilities and zoom lenses. This RV3D-in-one system could replace the traditional crystal or plastic lenses, and would provide more options and adjustments as required for each patient.

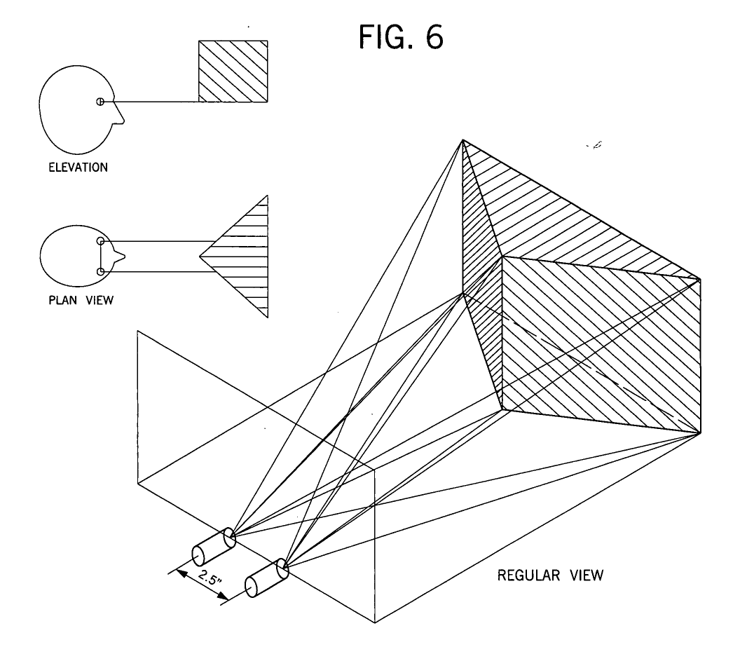

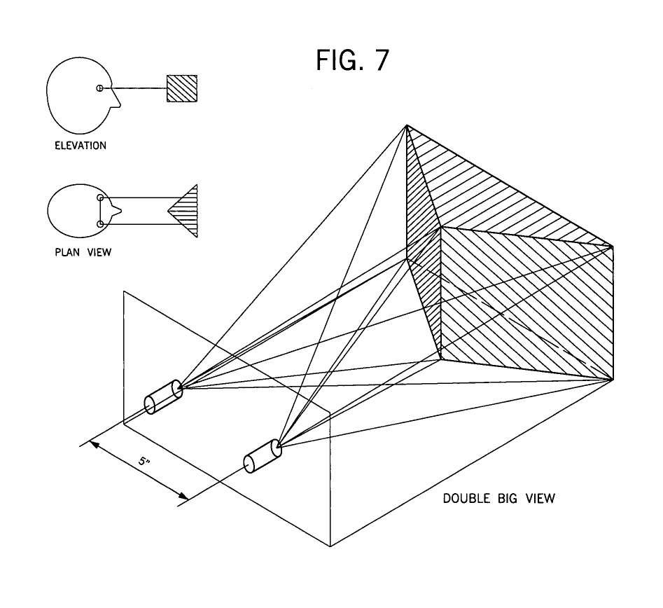

4. in this invention is the system of using a variable distance in between both lenses of the video cameras unit to provide a variable scale of perception because our human concept of space, distances, and size depends directly on the distance in between our two eyes (2.5 inches approximately) which is our natural way to measure our world and our concept of distance and space. FIG. 6 So, in the use of this real vision 3D system, if we double the distance between the center of the video lenses to 5 inches and the height of the camera unit's location to 11 feet, FIG. 7, the user will have the perception of being twice as big as before or will perceive the surroundings as if they had been shrank in half. The goggle unit, by the way, remains the same distance in between screens at all times. What varies is the distance in between the camera lenses. If we decrease the distance in between the center of the lenses from 2.5 inches, to a half (1.25 inches) and the camera's height to 3 feet, that would provide the perception of being half of our average size or everything around being twice as big. In that way, the system of sizing the scale of vision and perception, for bigger or smaller, allows us to apply RV3D in all sorts of ways. These applications may be very valuable mainly in the movie, commercial and medical industries. Another example could be for a larger distance in between lenses, such as a distance of 50 yards and the object to be recorded or observed at a minimum distance of 200 yards, which would provide a very well defined 3D observation of an object from a remote location. A smaller distance than 2.5 inches in between lenses, for example, 0.625 inches, would provide a 3D vision similar to that of an endoscope in the medical area, allowing a much closer observation of the objects of study. Also, this scale could be used in the observation and study of insects, going as small as needed in the distance between the left and right lenses of the cameras, allowing us to have the perception of being among the observed subjects and perceive ourselves at their size.

5. in this invention according to the concept described in the claim #4, is to use the Real Vision 3D System in the Medical Field as a 3D endoscopic instrument, giving doctors and surgeons the option to observe the study subjects in very detailed scale, enlarged for better observation, using a decreased distance in between the camera lenses, for example, 0.3125 inches or smaller if needed, and for displaying the observed material on the RV3D goggle unit.

6. in this invention is the use of a specially designed unit FIG. 3 where 6 the camera lenses are detachable from the 7 video control-storage unit, according to the concept described in the claim #4, for a larger distance than 2.5 inch in between camera lenses, where it is necessary to place both cameras (right and left) in different locations, with a variable distance in between them, and keeping the control and adjusting capabilities of the video recording to the operator of the 7 video control-storage unit that has the 3D viewfinders 4. For that purpose, each one of the cameras and the video control-storage unit has to have a tripod stand for support, battery, and communication devices for sending the video and audio signals cordlessly to the video control-storage unit. This allows the option of having an operator per camera apart from the operator at the video control-storage unit for faster and easier operation.

7. in this invention is to use satellite video and photography for the concept described in the claim #4, with a larger distance than 2.5 inches between camera lenses, using two satellites targeting one subject and displaying the video or photographic signals in a RV3D goggle unit, for 3D appreciation. In the use of this concept it will be required to set the parameters of distance in between satellites.

8. in this invention is the use of a specially designed attachable set of prismatic lenses to the RV3D camera unit FIG. 4, for the concept described in the claim #4, for a smaller distances than 2.5 inch in between camera lenses, where such distance can be adjustable.

9. in this invention is to use the Real Vision 3D in videogames, displaying them through the 3D goggle unit in a way to better produce a perception of 3D. The videogame's system would output two sets of streaming images to the goggle unit. The images would be of the same in-game situation, but each image would be rendered from a slightly different point. The rendering points would be separated at a distance that would create the scale of perception desired by the game company. For example, if the company wants to show the game through the perspective of a human, the render points could be at a distance equivalent to 2.5 inches at a height of 6 feet, so that the user may see the videogame world as if he/she were the human from which the game is viewed. The videogame companies could change the distance between render points and the height to achieve whatever perception they may desire to provide the user. Because two separate images are outputted to the goggle unit, one on the right screen and one on the left screen, according to their corresponding sides, a natural and more real sense of 3D is created.
